(19) United States
(12) Patent Application Publication
(10) Pub. No.: US 2026/0115923 A1
(43) Pub. Date: Apr. 30, 2026

(54) DEVICE AND METHOD FOR GUIDING MOBILE ROBOT

(71) Applicants: Hyundai Motor Company, Seoul (KR); Kia Corporation, Seoul (KR)

(72) Inventors: Changmo YANG, Gyeonggi-do (KR); Seongwon JANG, Gyeonggi-do (KR)

(21) Appl. No.: 19/118,602

(22) PCT Filed: Dec. 21, 2022
(86) PCT No.: PCT/KR2022/020940

§ 371 Date: Apr. 4, 2025

(30) Foreign Application Priority Data
Oct. 4, 2022 (KR) 10-2022-0126506

(51) Int. Cl. B25J 9/16; B25J 11/00; B25J 13/08; G05D 1/244; G05D 107/70

(52) U.S. Cl. CPC B25J 9/1684; B25J 9/1676; B25J 11/005; B25J 13/089; G05D 1/244; G05D 2107/70

(57) ABSTRACT

A device for guiding a mobile robot may include a vehicle information receiving module configured to receive vehicle information including vehicle type information of a vehicle having entered the process from a manufacturing execution system (MES), a guide information acquisition module configured to acquire guide information set to guide an operation of the mobile robot based on the vehicle information, a guide line projecting module configured to project a guide line on a vehicle workspace by driving a projector according to the guide information, and a mobile robot control module configured to recognize the projected the guide line, and control the mobile robot along the recognized the guide line.

### TECHNICAL FIELD

The present disclosure relates to a device and a method for guiding a mobile robot.

### BACKGROUND ART

Vision quality inspection methods using mobile robots are attracting attention in the assembly process of producing various industrial products such as automobiles. The mobile robot may be a robot that can understand the environment in an industrial site, move around, and assist or perform tasks on behalf of people, and unlike an automated guided vehicle (AGV) that relies on a predefined path, the mobile robot is equipped with various types of sensors including cameras, computer vision sensors, voice recognition sensors, and lidar, and uses computing technologies such as artificial intelligence and machine learning to collect data about the environment and make decisions on its own, such as setting a path. Recently, quadruped mobile robots with increased mobility have been used to enable photographing in locations that are difficult for humans to access.

A mobile robot can, for example, move to a location and take pictures based on fiducial marks that are marked in advance in the vehicle workspace. That is, the fiducial mark can guide the photographing position of the mobile robot. However, in a mixed-type manufacturing plant that manufactures vehicles of multiple types and options according to small-quantity multiple-type production scheme, the photographing position may vary depending on the vehicle type or option.

### DISCLOSURE

### Technical Problem

The present disclosure attempts to provide a device and a method for guiding a mobile robot, capable of controlling the mobile robot safely and effectively without being limited to the vehicle type in a mixed-type manufacturing plant that manufactures vehicles of multiple types and options.

### Technical Solution

A device for guiding a mobile robot may include a vehicle information receiving module configured to receive vehicle information including vehicle type information of a vehicle having entered the process from a manufacturing execution system (MES), a guide information acquisition module configured to acquire guide information set to guide an operation of the mobile robot based on the vehicle information, a guide line projecting module configured to project a guide line on a vehicle workspace by driving a projector according to the guide information, and a mobile robot control module configured to recognize the projected the guide line, and control the mobile robot along the recognized the guide line.

The guide information may include at least one of safe driving path guide information set for the mobile robot to drive without collision with another object, and centering guide information set for the mobile robot to be located for photographing at a preset location.

The guide line projecting module may be configured to project a safe driving path guide line on the vehicle workspace by driving the projector according to the safe driving path guide information.

The mobile robot control module may be configured to control the mobile robot to stop, when the mobile robot deviates from the safe driving path guide line.

The guide line projecting module may be configured to project a new safe driving path guide line, when an object that is determined to be potentially collided by the mobile robot is recognized on the safe driving path guide line that is being currently projected.

The guide line projecting module may be configured to project a centering guide line on the vehicle workspace by driving the projector according to the centering guide information.

The centering guide line may include a plurality of leg position-corresponding points corresponding to a leg position of the mobile robot, and the mobile robot control module may be configured to move the mobile robot, so that the plurality of leg position-corresponding points and the leg of the mobile robot coincide with each other on the centering guide line.

The centering guide line may include a torso-corresponding center line corresponding to a center line of the torso of the mobile robot in one axis direction, and the mobile robot control module may be configured to move the mobile robot, so that the torso-corresponding center line on the centering guide line and the center line of the torso of the mobile robot coincide with each other.

The centering guide line may include a moving direction indicating marker configured to indicate a direction in which the mobile robot can move, and the mobile robot control module may be configured to move the mobile robot to another centering guide line according to the moving direction indicating marker.

The guide line projecting module may be configured to display a new moving direction indicating marker that is set so that the mobile robot moves in second direction that is opposite to the first direction, when an object that is determined to be potentially collided by the mobile robot while when the mobile robot moves in first direction along the moving direction indicating marker that is currently being projected is recognized.

A device for guiding a mobile robot may include a guide information acquisition module configured to acquire a predetermined first guide information to guide an operation of the mobile robot based on first vehicle information including vehicle type information of a first vehicle, and a predetermined second guide information to guide the operation of the mobile robot based on second vehicle information including vehicle type information of a second vehicle having a different vehicle type from the first vehicle, a guide line projecting module configured to project first guide line on a vehicle workspace by driving a projector according to the first guide information, when the first vehicle has entered the process, and a mobile robot control module configured to recognize the projected first guide line, and control the mobile robot along the recognized first guide line, where, when the second vehicle has entered the process, the guide line projecting module may be configured to stop projection of the first guide line, and project second guide line on the vehicle workspace by driving the projector according to the second guide information, and where the mobile robot control module may be configured to recognize the projected second guide line, and control the mobile robot along the recognized second guide line.

The first guide information may include at least one of first safe driving path guide information set for the mobile robot to drive without collision with another object in connection with the first vehicle, and first centering guide information set for the mobile robot to be located for photographing at a preset location in connection with the first vehicle, and the second guide information may include at least one of second safe driving path guide information set for the mobile robot to drive without collision with another object in connection with the second vehicle, and second centering guide information set for the mobile robot to be located for photographing at a preset location in connection with the second vehicle.

The guide line projecting module may be configured to project a first safe driving path guide line or a second safe driving path guideline on the vehicle workspace by driving the projector according to the first safe driving path guide information or the second safe driving path guide information.

The guide line projecting module may be configured to project a new safe driving path guide line, when an object that is determined to be potentially collided by the mobile robot is recognized on the safe driving path guide line that is being currently projected.

The guide line projecting module may be configured to project a first centering guide line or a second centering guide line on the vehicle workspace by driving the projector according to the first centering guide information or the second centering guide information.

A mobile robot guide method may include receiving vehicle information including vehicle type information of a vehicle having entered the process from MES, acquiring guide information set to guide an operation of the mobile robot based on the vehicle information, projecting a guide line on a vehicle workspace by driving a projector according to the guide information, and recognizing the projected the guide line, and control the mobile robot along the recognized the guide line.

The guide information may include at least one of safe driving path guide information set for the mobile robot to drive without collision with another object, and centering guide information set for the mobile robot to be located for photographing at a preset location.

The projecting the guide line may include projecting a safe driving path guide line on the vehicle workspace by driving the projector according to the safe driving path guide information.

The projecting the guide line may further include projecting a new safe driving path guide line, when an object that is determined to be potentially collided by the mobile robot is recognized on the safe driving path guide line that is being currently projected.

The projecting the guide line may include projecting a centering guide line on the vehicle workspace by driving the projector according to the centering guide information.

### Advantageous Effects

According to an embodiment, by projecting guide lines appropriate for various vehicle types or options by using a projector installed in the vehicle workspace, and by controlling the mobile robot based on this, the mobile robot can be accurately moved to a desired photographing position without being limited to the vehicle type, or a collision with an obstacle or a worker in a blind region where obstacle detection is impossible due to sensor configuration of the mobile robot may be prevented in advance.

### DESCRIPTION OF THE DRAWINGS

FIG. 1 and FIG. 2 are drawings for explaining a mobile robot guide system according to an embodiment.

FIG. 3 is a drawing for explaining a guide line of a mobile robot guide system according to an embodiment.

FIG. 4 is a drawing for explaining a safe driving path guide line of a mobile robot guide system according to an embodiment.

FIG. 5 is a drawing for explaining a centering guide line of a mobile robot guide system according to an embodiment.

FIG. 6 is a drawing for explaining a centering guide line of a mobile robot guide system according to an embodiment.

FIG. 7 is a drawing for explaining a centering guide line of a mobile robot guide system according to an embodiment.

FIG. 8 is a drawing for explaining a centering guide line of a mobile robot guide system according to an embodiment.

FIG. 9 is a drawing for explaining a centering guide line of a mobile robot guide system according to an embodiment.

FIG. 10 is a drawing for explaining a mobile robot guide method according to an embodiment.

FIG. 11 is a drawing for explaining a mobile robot guide method according to an embodiment.

FIG. 12 is a drawing for explaining a mobile robot guide method according to an embodiment.

FIG. 13 is a drawing for explaining an embodiment of a computing device for implementing a device and a method for guiding a mobile robot according to embodiments.

### MODE FOR INVENTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and claims, when a part “includes” a certain element, it means that other elements may be further included, rather than excluding other elements, unless otherwise stated. Terms including ordinal numbers such as first, second, and the like will be used only to describe various constituent elements, and are not to be interpreted as limiting these constituent elements. The terms are only used to differentiate one constituent element from other constituent elements.

The terms “unit”, “part” or “portion”, “-er”, and “module” in the specification refer to a unit that processes at least one function or operation, which may be implemented by hardware, software, or a combination of hardware and software. In addition, at least a partial configuration or function of a device and a method for guiding a mobile robot according to embodiments described below may be implemented as a program or software, and the program or software may be stored in a computer-readable medium.

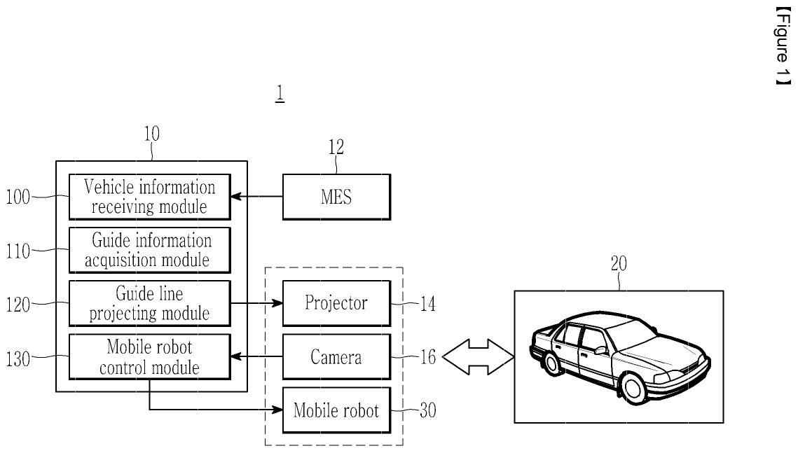

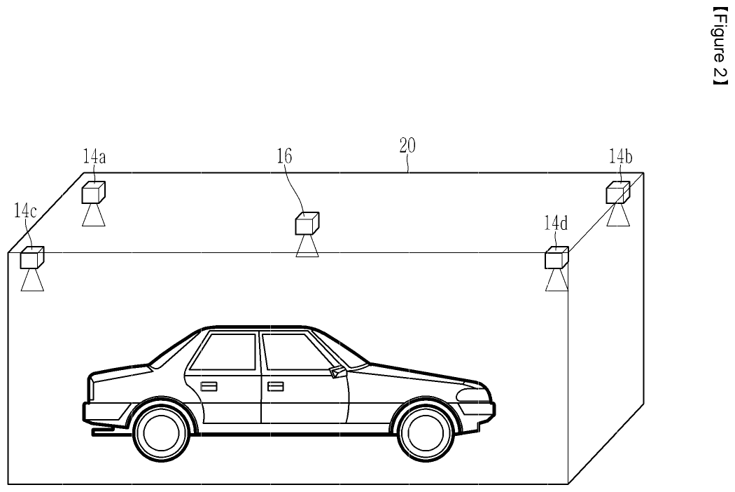

FIG. 1 and FIG. 2 are drawings for explaining the mobile robot guide system according to an embodiment.

Referring to FIG. 1, the mobile robot guide system 1 according to an embodiment may include a device for guiding a mobile robot 10, a manufacturing execution system (MES) 12, a projector 14, a camera 16, a vehicle workspace 20 and the mobile robot 30.

The device for guiding a mobile robot 10 may control a movement of the mobile robot 30 regardless of structural differences occurring depending on the vehicle type and option in the multiple-type multiple-option vehicle assembly process of the vehicle manufacturing plant, and may include a vehicle information receiving module 100, a guide information acquisition module 110, a guide line projecting module 120, and a mobile robot control module 130.

The vehicle information receiving module 100 may receive the vehicle information including vehicle type information of the vehicle having entered the process from the manufacturing execution system (MES) 12. In some embodiments, the vehicle information may further include specification information on information on options applicable to the vehicle. In some embodiments, the vehicle information received from the MES 12 may include information on the vehicle body according to the corresponding vehicle type and inspection schedule information including quality inspections to be performed with respect to the corresponding vehicle body, and the mobile robot 30 may perform inspections described in the inspection schedule information with respect to the corresponding vehicle body.

For example, the inspection schedule information may include information on the photographing position at which the mobile robot 30 performs the quality inspection. When the vehicle information receiving module 100 receives the information on the photographing position from the MES 12, the mobile robot control module 130 may control the mobile robot 30 to move to the corresponding photographing position to perform the quality inspection through image photographing.

The guide information acquisition module 110 may acquire guide information set to guide an operation of the mobile robot 30 based on the vehicle information received by the vehicle information receiving module 100 from the MES 12. The guide information may include at least one of safety driving guide information and centering guide information. The safety driving guide information may be information on positions or regions within the vehicle workspace 20 set for the mobile robot 30 to drive without collision with another object. The centering guide information may be information on positions or regions within the vehicle workspace 20 set for the mobile robot to be located for photographing.

The guide line projecting module 120 may project the guide line on the vehicle workspace 20 by driving the projector 14 according to the guide information, and the mobile robot control module 130 may recognize the projected guide line by using the camera 16, and may control the mobile robot 30 along the recognized guide line. Here, the projector 14 and the camera 16 may be installed on the vehicle workspace 20.

Referring to together FIG. 2, in some embodiments, the projector 14 may include a plurality of projectors 14a, 14b, 14c, and 14d, and the plurality of projectors 14a, 14b, 14c, and 14d and the camera 16 may be installed in the vehicle workspace 20. The plurality of projectors 14a, 14b, 14c, and 14d may be installed at appropriately spaced positions so as to be able to project only all regions of the front, rear, left, and right of the vehicle located at a center of the vehicle workspace 20. Of course, in the embodiments, the number, the installation position, or the like, of the projector 14 is not limited to a specific number, a particular location, or the like.

In some embodiments, the guide line projecting module 120 may project a safe driving path guide line on the vehicle workspace 20 by driving the projector 14 according to the safety driving guide information. The mobile robot 30 may move along the safe driving path guide line projected on the vehicle workspace 20, and when the mobile robot 30 deviates from the safe driving path guide line, the mobile robot control module 130 may control the mobile robot 30 to stop.

In some embodiments, the guide line projecting module 120 may project a centering guide line on the vehicle workspace by driving the projector 14 according to the centering guide information. The mobile robot 30 may move along the centering guide line projected on the vehicle workspace 20 and perform photographing for the quality inspection.

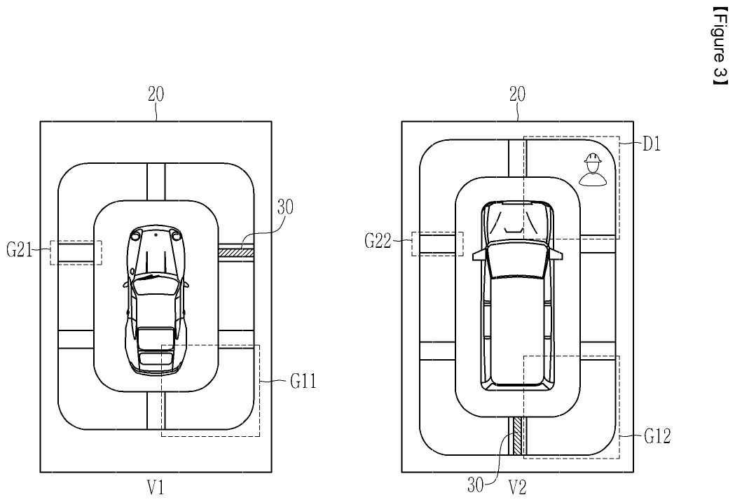

FIG. 3 is a drawing for explaining the guide line of the mobile robot guide system according to an embodiment.

Referring to FIG. 3, with respect to a first vehicle type V1, the guide line projected on the vehicle workspace 20 may include the safe driving path guide line G11 and a centering guide line G21. As shown in the drawings, the centering guide line G21 may be projected on six points corresponding to a front surface, a front left door, a rear left door, a rear surface, a rear right door, and a front right door of the vehicle, and the safe driving path guide line G11 may be projected in a region between the centering guide lines G21. The mobile robot 30 may move along the safe driving path guide line G11 without collision with an obstacle or a worker, and after accurately recognizing positions of the front surface, the front left door, the rear left door, the rear surface, the rear right door, and the front right door of the vehicle, which is the first vehicle type V1, along the centering guide line G21, may move to the corresponding position and perform photographing for the quality inspection.

After the work with respect to the vehicle of the first vehicle type V1 is completed, the vehicle of a second vehicle type V2 different from the first vehicle type V1 may enter, and the safe driving path guide line G12 and a centering guide line G22 may be projected with respect to the second vehicle type V2. As shown in the drawings, the centering guide line G22 may be projected on six points corresponding to the front surface, the front left door, the rear left door, the rear surface, the rear right door, and the front right door of the vehicle, and the safe driving path guide line G12 may be projected onto a region where there is no possibility of collision with an obstacle or the worker among regions between the centering guide lines G22. The mobile robot 30 may move along the safe driving path guide line G12 without collision with the obstacle or the worker, and may not move to a collision-potential region D1 where there exists a possibility of collision with the obstacle or the worker. In addition, after accurately recognizing positions of the front surface, the front left door, the rear left door, the rear surface, the rear right door, and the front right door of the vehicle, which is the second vehicle type V2, along the centering guide line G22, the mobile robot 30 may move to the corresponding position and perform photographing for the quality inspection.

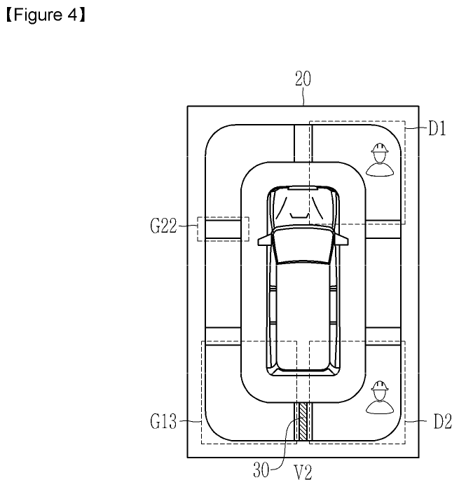

FIG. 4 is a drawing for explaining the safe driving path guide line of the mobile robot guide system according to an embodiment.

Referring to FIG. 4, when the object that is determined to be potentially collided by the mobile robot 30 is recognized on the safe driving path guide line that is being currently projected, the guide line projecting module 120 may project a new safe driving path guide line. As shown in FIG. 3, when it is recognized through the camera 16 that the worker has entered the safe driving path guide line G12 that is being projected, the guide line projecting module 120 may change the safe driving path guide line G12 to a collision-potential region D2, and may project a new safe driving path guide line G13. Accordingly, the mobile robot 30 may move along the safe driving path guide line G13 without collision with the obstacle or the worker, and may not move to the collision-potential regions D1 and D2 where there exists a possibility of collision with the obstacle or the worker.

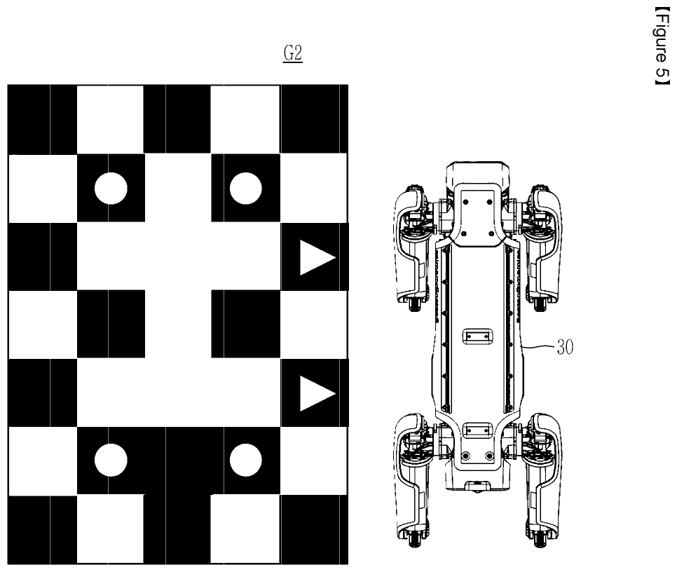

FIG. 5 is a drawing for explaining a centering guide line of the mobile robot guide system according to an embodiment.

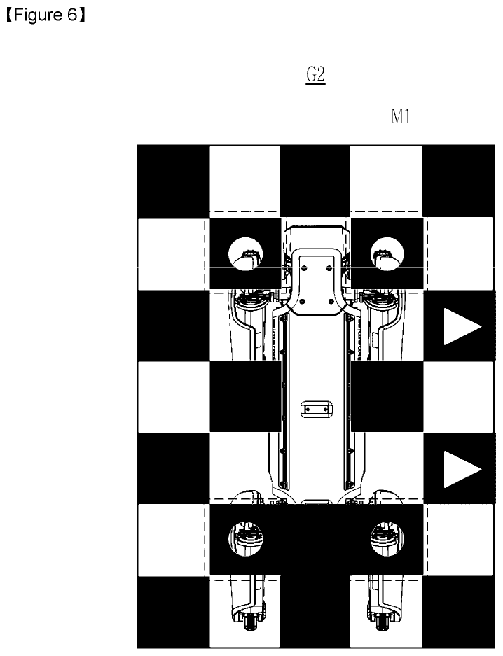

Referring to FIG. 5, the centering guide line G2 of the mobile robot guide system according to an embodiment is for locating the mobile robot 30 at a center or indicating a direction in which the mobile robot 30 can move, and for example, may include a lattice pattern in which black and white colors are repeated, as illustrated in the drawings. Before the mobile robot 30 enters the centering guide line G2, the central position and front and rear directions can be recognized through image recognition through the camera 16. Hereinafter, in connection to FIG. 6 to FIG. 9, the case in which the mobile robot 30, as illustrated to be quadruped in the drawings, enters the centering guide line G2 will be described in detail.

FIG. 6 is a drawing for explaining a centering guide line of the mobile robot guide system according to an embodiment.

Referring to FIG. 6, the centering guide line G2 of the mobile robot guide system according to an embodiment may include a plurality of leg position-corresponding points M1 corresponding to a leg position of the mobile robot 30. Since the illustrated mobile robot 30 has four legs, the centering guide line G2 may include four leg position-corresponding points M1. When the plurality of leg position-corresponding points M1 is identified through the camera 16, the mobile robot control module 130 may move the mobile robot 30 so that the plurality of leg position-corresponding points M1 and the leg of the mobile robot 30 may coincide with each other on the centering guide line G2.

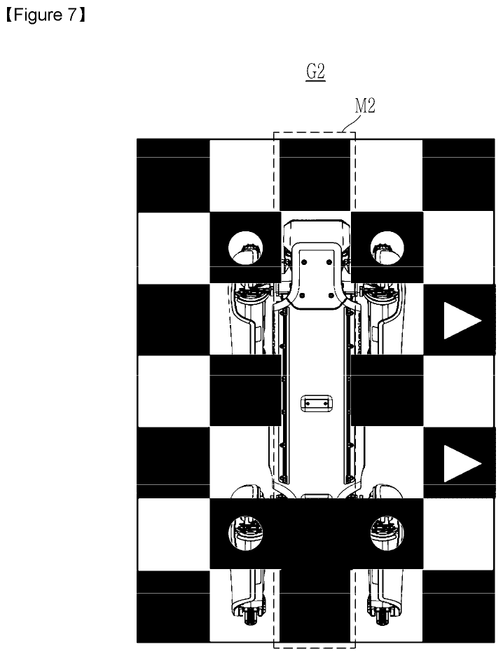

FIG. 7 is a drawing for explaining a centering guide line of the mobile robot guide system according to an embodiment.

Referring to FIG. 7, the centering guide line G2 of the mobile robot guide system according to an embodiment may include a torso-corresponding center line M2 corresponding to a center line of the torso of the mobile robot 30 in one axis direction. When the torso-corresponding center line M2 is identified through the camera 16, the mobile robot control module 130 may move the mobile robot 30 so that the torso-corresponding center line M2 on the centering guide line G2 may coincide with the center line of the torso of the mobile robot 30.

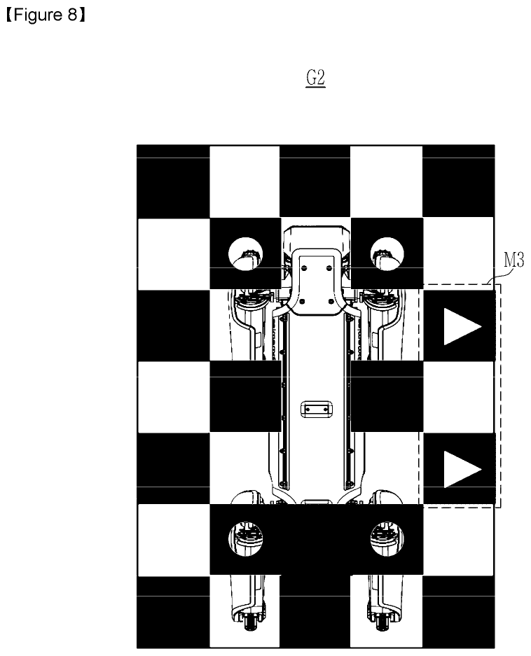

FIG. 8 is a drawing for explaining a centering guide line of the mobile robot guide system according to an embodiment.

Referring to FIG. 8, the centering guide line G2 of the mobile robot guide system according to an embodiment may include a moving direction indicating marker M3 indicating a direction in which the mobile robot 30 can move. When the moving direction indicating marker M3 is identified through the camera 16, the mobile robot control module 130 may move the mobile robot 30 to another centering guide line according to the moving direction indicating marker M3.

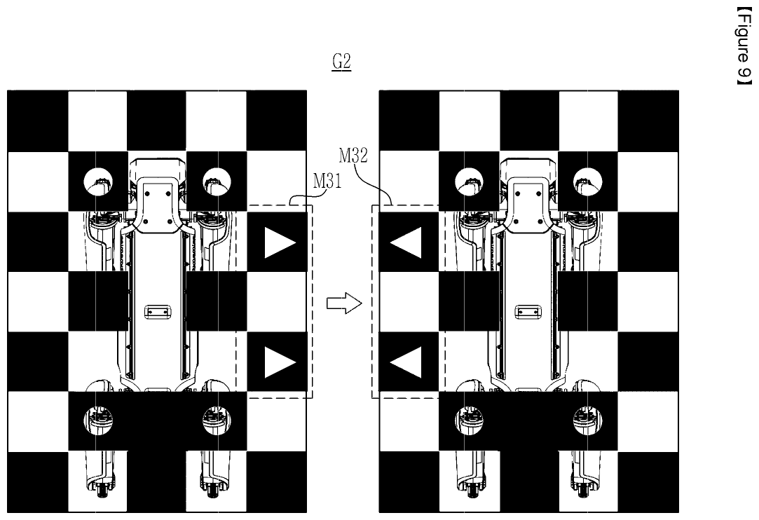

FIG. 9 is a drawing for explaining a centering guide line of the mobile robot guide system according to an embodiment.

Referring to FIG. 9, when the object that is determined to be potentially collided by the mobile robot 30 is recognized while the mobile robot 30 moves in a first direction along the moving direction indicating marker that is currently being projected, the guide line projecting module 120 may display a new moving direction indicating marker that is set so that the mobile robot 30 moves in a second direction that is opposite to the first direction. As shown on the left of FIG. 9, through the camera 16, when the object that is determined to be potentially collided by the mobile robot 30 is recognized while the mobile robot 30 moves to the right along the moving direction indicating marker M31 that is currently being projected, the guide line projecting module 120 may stop projection of the moving direction indicating marker M31, and may display a new moving direction indicating marker M32 set for the mobile robot 30 to move to the left. Accordingly, the mobile robot 30 may not move to the direction having the possibility of collision with the obstacle or the worker.

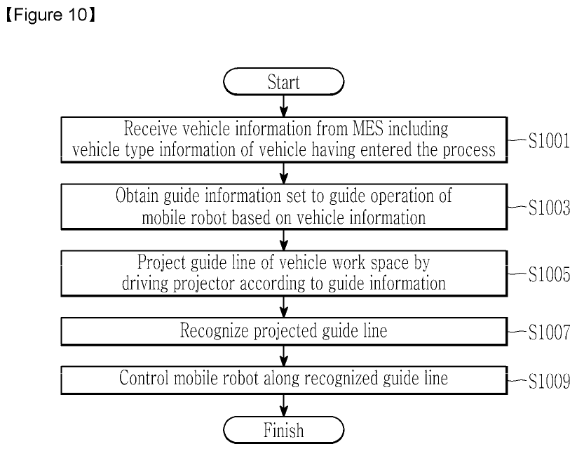

FIG. 10 is a drawing for explaining the mobile robot guide method according to an embodiment.

Referring to FIG. 10, at step S1001, the mobile robot guide method according to an embodiment may receive the vehicle information including the vehicle type information of the vehicle having entered the process from the MES 12, and at step S1003, may acquire guide information set to guide the operation of the mobile robot 30 based on the vehicle information. In addition, the method may project the guide line on the vehicle workspace by driving the projector 14 according to the guide information at step S1005, may recognize the projected guide line by using the camera 16 at step S1007, and control the mobile robot 30 along the recognized guide line at step S1009.

For further details in connection with the mobile robot guide method according to the present embodiment, the description in connection with FIG. 1 to FIG. 9 may be referred to, and redundant description will not be included herein.

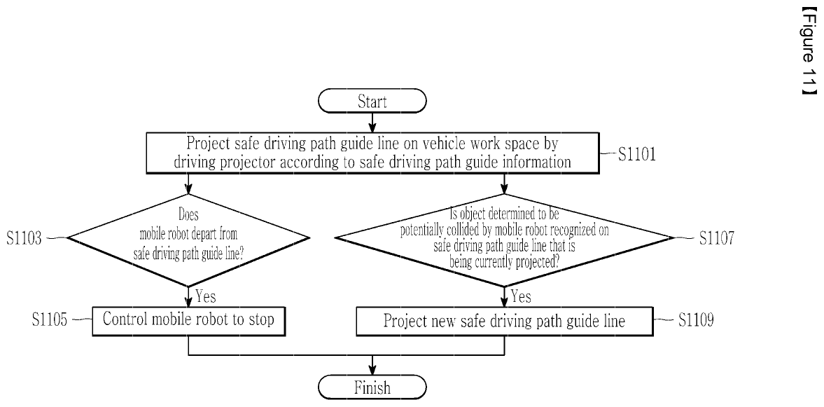

FIG. 11 is a drawing for explaining the mobile robot guide method according to an embodiment.

Referring to FIG. 11, at step S1101, the mobile robot guide method according to an embodiment may project the safe driving path guide line on the vehicle workspace 20 by driving the projector 14 according to safe driving path guide information, and at step S1103, may determine whether the mobile robot 30 is out of the safe driving path guide line. When it is determined that the mobile robot 30 is out of the safe driving path guide line, at step S1105, the mobile robot 30 may be controlled to stop.

Meanwhile, at step S1107, whether the object that is determined to be potentially collided by the mobile robot 30 is recognized on the safe driving path guide line that is being currently projected may be determined. When it is determined that the object that is determined to be potentially collided by the mobile robot 30 is recognized on the safe driving path guide line that is being currently projected, at step S1109, a new safe driving path guide line may be projected.

For further details of the mobile robot guide method according to the present embodiment, the description in connection with FIG. 1 to FIG. 9 may be referred to, and redundant description will not be included herein.

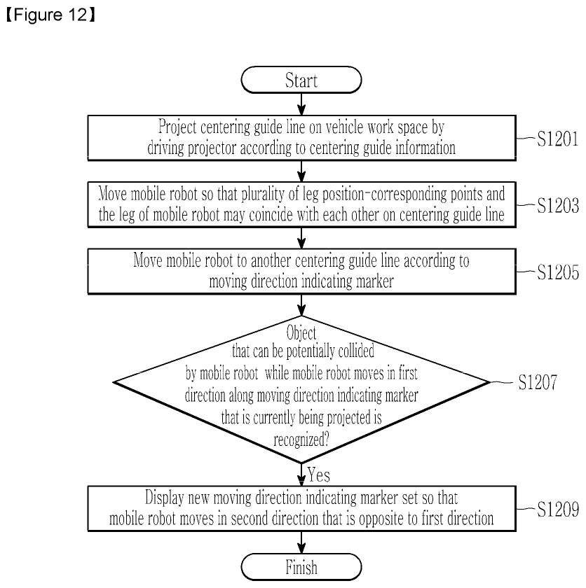

FIG. 12 is a drawing for explaining the mobile robot guide method according to an embodiment.

Referring to FIG. 12, at step S1201, the mobile robot guide method according to an embodiment may project a centering guide line on the vehicle workspace 20 by driving the projector 14 according to the centering guide information, and at step S1203, may move the mobile robot 30 so that the plurality of leg position-corresponding points and the leg of the mobile robot 30 may coincide with each other on the centering guide line.

In addition, at step S1205, the method may move the mobile robot 30 to another centering guide line according to the moving direction indicating marker, and at step S1207, may determine whether an object that can be potentially collided while the mobile robot 30 moves in the first direction along the moving direction indicating marker that is currently being projected is recognized. When it is determined that an object that can be potentially collided is recognized while the mobile robot 30 moves in the first direction along the moving direction indicating marker that is currently being projected, at step S1209, the new moving direction indicating marker that is set so that the mobile robot 30 moves in the second direction that is opposite to the first direction may be displayed.

For further details of the mobile robot guide method according to the present embodiment, the description in connection with FIG. 1 to FIG. 9 may be referred to, and redundant description will not be included herein.

In some embodiments, the device for guiding a mobile robot 10 may operate with respect to different vehicle types. Specifically, the guide information acquisition module 110 may acquire a predetermined first guide information to guide the operation of the mobile robot 30 based on first vehicle information including vehicle type information of the first vehicle, and a predetermined second guide information to guide the operation of the mobile robot 30 based on the second vehicle information including vehicle type information of the second vehicle having a different vehicle type from the first vehicle.

When the first vehicle has entered the process, the guide line projecting module 120 may project a plurality of first guide lines on the vehicle workspace 20 by driving the projector 14 according to first guide information, and the mobile robot control module 130 may recognize the projected plurality of first guide lines, and may control the mobile robot 30 along the recognized plurality of first guide lines.

Subsequently, when the second vehicle has entered the process, the guide line projecting module 120 may stop the projection of the plurality of first guide lines, and project a plurality of second guide line on the vehicle workspace 20 by driving the projector 14 according to second guide information, and the mobile robot control module 130 may recognize the projected plurality of second guide line, and control the mobile robot 30 along the recognized plurality of second guide line.

Here, first guide information may include at least one of first safe driving path guide information set for the mobile robot 30 to drive without collision with another object in connection with the first vehicle and first centering guide information set for the mobile robot 30 to be located at a preset location for photographing in connection with the first vehicle, and second guide information may include at least one of second safe driving path guide information set for the mobile robot 30 to drive without collision with another object in connection with the second vehicle, and second centering guide information set for the mobile robot 30 to be located at a preset location for photographing in connection with the second vehicle.

The guide line projecting module 120 may project a first safe driving path guide line or a second safe driving path guideline on the vehicle workspace 20 by driving the projector 14 according to the first safe driving path guide information or the second safe driving path guide information, and may project a first centering guide line or a second centering guide line on the vehicle workspace 20 by driving the projector 14 according to the first centering guide information or the second centering guide information.

According to an embodiment described above, by projecting guide lines appropriate for various vehicle types or options by using a projector installed in the vehicle workspace and controlling the mobile robot based on this, the mobile robot can be accurately moved to a desired photographing position without being limited to the vehicle type, or a collision with an obstacle or a worker in a blind region where obstacle detection is impossible due to sensor configuration of the mobile robot may be prevented in advance.

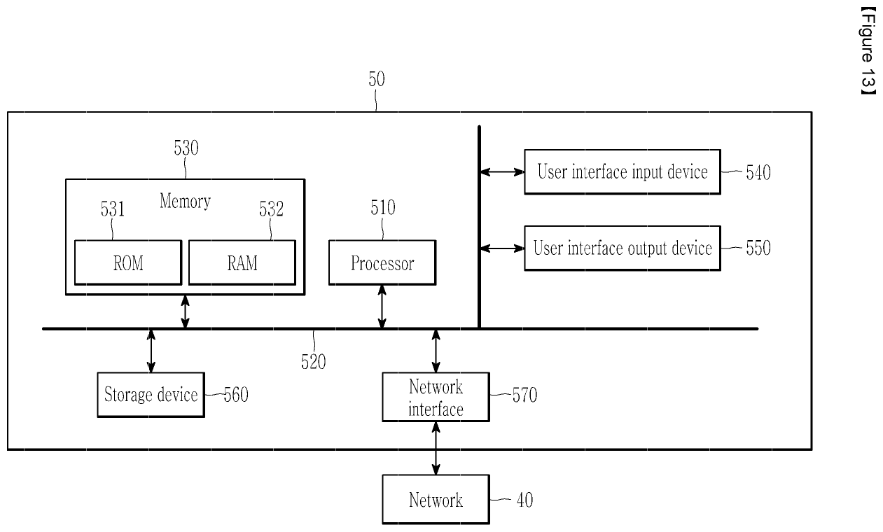

FIG. 13 is a drawing for explaining an embodiment of a computing device for implementing a device and a method for guiding a mobile robot according to embodiments.

Referring to FIG. 13, a device and a method for guiding a mobile robot according to embodiments may be implemented by using a computing device 500.

The computing device 500 may include at least one of a processor 510, a memory 530, a user interface input device 540, a user interface output device 550 and a storage device 560 that communicate with each other through a bus 520. The computing device 500 may include a network interface 570 electrically connected to a network 40. The network interface 570 may send or receive signals to and from other entities through the network 40.

The processor 510 may be implemented in various types, such as a micro controller unit (MCU), an application processor (AP), a central processing unit (CPU), a graphic processing unit (GPU), a neural processing unit (NPU), and the like, may be any semiconductor device configured to execute instructions stored in the memory 530 or the storage device 560. The processor 510 may be configured to implement function and methods described above with reference to FIG. 1 to FIG. 12.

The memory 530 and the storage device 560 may include various types of volatile or non-volatile storage media. For example, the memory may include a read-only memory (ROM) 531 and a random access memory (RAM) 532. In the present embodiment, the memory 530 may be positioned in an interior or exterior of the processor 510, and the memory 530 may be connected to the processor 510 through various known means.

In some exemplary embodiments, at least some of the configurations or functions of a device and a method for guiding a mobile robot according to the exemplary embodiments may be implemented by programs or software executed by the computing device 500, and the programs or software may be stored in a computer-readable medium.

In some embodiments, at least partial configuration or function of a device and a method for guiding a mobile robot according to embodiments may be implemented as a hardware that can be electrically connected to the computing device 500.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

1. A device for guiding a mobile robot, comprising:
a vehicle information receiving module configured to receive vehicle information comprising vehicle type information of a vehicle having entered the process from a manufacturing execution system (MES);
a guide information acquisition module configured to acquire guide information set to guide an operation of the mobile robot based on the vehicle information;
a guide line projecting module configured to project a guide line on a vehicle workspace by driving a projector according to the guide information; and
a mobile robot control module configured to recognize the projected the guide line, and control the mobile robot along the recognized the guide line.

2. The device for guiding a mobile robot of claim 1, wherein the guide information comprises at least one of safe driving path guide information set for the mobile robot to drive without collision with another object, and centering guide information set for the mobile robot to be located for photographing at a preset location.

3. The device for guiding a mobile robot of claim 2, wherein the guide line projecting module is configured to project a safe driving path guide line on the vehicle workspace by driving the projector according to the safe driving path guide information.

4. The device for guiding a mobile robot of claim 3, wherein the mobile robot control module is configured to control the mobile robot to stop, when the mobile robot deviates from the safe driving path guide line.

5. The device for guiding a mobile robot of claim 3, wherein the guide line projecting module is configured to project a new safe driving path guide line, when an object that is determined to be potentially collided by the mobile robot is recognized on the safe driving path guide line that is being currently projected.

6. The device for guiding a mobile robot of claim 2, wherein the guide line projecting module is configured to project a centering guide line on the vehicle workspace by driving the projector according to the centering guide information.

7. The device for guiding a mobile robot of claim 6, wherein:
the centering guide line comprises a plurality of leg position-corresponding points corresponding to a leg position of the mobile robot; and
the mobile robot control module is configured to move the mobile robot, so that the plurality of leg position-corresponding points and the leg of the mobile robot coincide with each other on the centering guide line.

8. The device for guiding a mobile robot of claim 6, wherein:
the centering guide line comprises a torso-corresponding center line corresponding to a center line of the torso of the mobile robot in one axis direction; and
the mobile robot control module is configured to move the mobile robot, so that the torso-corresponding center line on the centering guide line and the center line of the torso of the mobile robot coincide with each other.

9. The device for guiding a mobile robot of claim 6, wherein:
the centering guide line comprises a moving direction indicating marker configured to indicate a direction in which the mobile robot can move; and
the mobile robot control module is configured to move the mobile robot to another centering guide line according to the moving direction indicating marker.

10. The device for guiding a mobile robot of claim 9, wherein the guide line projecting module is configured to display a new moving direction indicating marker that is set so that the mobile robot moves in second direction that is opposite to the first direction, when an object that is determined to be potentially collided by the mobile robot while when the mobile robot moves in first direction along the moving direction indicating marker that is currently being projected is recognized.

11. A device for guiding a mobile robot, comprising:
a guide information acquisition module configured to acquire a predetermined first guide information to guide an operation of the mobile robot based on first vehicle information comprising vehicle type information of a first vehicle, and a predetermined second guide information to guide the operation of the mobile robot based on second vehicle information comprising vehicle type information of a second vehicle having a different vehicle type from the first vehicle;
a guide line projecting module configured to project first guide line on a vehicle workspace by driving a projector according to the first guide information, when the first vehicle has entered the process; and
a mobile robot control module configured to recognize the projected first guide line, and control the mobile robot along the recognized first guide line,
wherein, when the second vehicle has entered the process, the guide line projecting module is configured to stop projection of the first guide line, and project second guide line on the vehicle workspace by driving the projector according to the second guide information, and
Wherein the mobile robot control module is configured to recognize the projected second guide line, and control the mobile robot along the recognized second guide line.

12. The device for guiding a mobile robot of claim 11, wherein:
the first guide information comprises at least one of first safe driving path guide information set for the mobile robot to drive without collision with another object in connection with the first vehicle, and first centering guide information set for the mobile robot to be located for photographing at a preset location in connection with the first vehicle; and
the second guide information comprises at least one of second safe driving path guide information set for the mobile robot to drive without collision with another object in connection with the second vehicle, and second centering guide information set for the mobile robot to be located for photographing at a preset location in connection with the second vehicle.

13. The device for guiding a mobile robot of claim 12, wherein the guide line projecting module is configured to project a first safe driving path guide line or a second safe driving path guideline on the vehicle workspace by driving the projector according to the first safe driving path guide information or the second safe driving path guide information.

14. The device for guiding a mobile robot of claim 13, wherein the guide line projecting module is configured to project a new safe driving path guide line, when an object that is determined to be potentially collided by the mobile robot is recognized on the safe driving path guide line that is being currently projected.

15. The device for guiding a mobile robot of claim 12, wherein the guide line projecting module is configured to project a first centering guide line or a second centering guide line on the vehicle workspace by driving the projector according to the first centering guide information or the second centering guide information.

16. A method for guiding a mobile robot, comprising:
receiving vehicle information comprising vehicle type information of a vehicle having entered the process from MES;
acquiring guide information set to guide an operation of the mobile robot based on the vehicle information;
projecting a guide line on a vehicle workspace by driving a projector according to the guide information; and
recognizing the projected the guide line, and control the mobile robot along the recognized the guide line.

17. The method for guiding a mobile robot of claim 16, wherein the guide information comprises at least one of safe driving path guide information set for the mobile robot to drive without collision with another object, and centering guide information set for the mobile robot to be located for photographing at a preset location.

18. The method for guiding a mobile robot of claim 17, wherein the projecting the guide line comprises projecting a safe driving path guide line on the vehicle workspace by driving the projector according to the safe driving path guide information.

19. The method for guiding a mobile robot of claim 18, wherein the projecting the guide line further comprises projecting a new safe driving path guide line, when an object that is determined to be potentially collided by the mobile robot is recognized on the safe driving path guide line that is being currently projected.

20. The method for guiding a mobile robot of claim 17, wherein the projecting the guide line comprises projecting a centering guide line on the vehicle workspace by driving the projector according to the centering guide information.
